(19) United States
(12) Patent Application Publication
(10) Pub. No.: US 2013/0185487 A1
(43) Pub. Date: Jul. 18, 2013

(54) MEMORY SYSTEM AND MOBILE DEVICE INCLUDING HOST AND FLASH MEMORY-BASED STORAGE DEVICE

(71) Applicants: Jin Seok KIM, Seoul (KR); Kyung Ho KIM, Seoul (KR); Hyunchul PARK, Ansan-si (KR); Seunguk SHIN, Seoul (KR); Otae BAE, Daegu (KR)

(72) Inventors: Jin Seok KIM, Seoul (KR); Kyung Ho KIM, Seoul (KR); Hyunchul PARK, Ansan-si (KR); Seunguk SHIN, Seoul (KR); Otae BAE, Daegu (KR)

(73) Assignee: Samsung Electronics Co., Ltd, Suwon-si (KR)

(21) Appl. No.: 13/744,603

(22) Filed: Jan. 18, 2013

(30) Foreign Application Priority Data
Jan. 18, 2012 (KR) 10-2012-0005764
Jan. 7, 2013 (KR) 10-2013-0001708

(51) Int. Cl. G06F 12/02; G06F 12/00

(52) U.S. Cl. CPC G06F 12/0246; G06F 12/00
USPC 711/103; 711/156

(57) ABSTRACT

A memory system is provided which includes a storage device including a flash memory; and a host configured to request a storage device state and user pattern information via a user interface, to analyze the user pattern information, to set up a parameter of the storage device such that the storage device operates an optimization operation, according to the analyzing result, and to provide a command for the optimization operation to the storage device.

### CROSS-REFERENCE TO RELATED APPLICATIONS

A claim for priority under 35 U.S.C. §119 is made to Korean Patent Application No. 10-2012-0005764 filed Jan. 18, 2012 and Korean Patent Application No. 10-2013-0001708 filed Jan. 7, 2013, in the Korean Intellectual Property Office, the entire contents of which are hereby incorporated by reference.

### BACKGROUND OF THE INVENTION

1. Field of the Invention

The inventive concepts described herein relate to a memory system and a mobile device including a host and a flash memory-based storage device.

2. Description of the Related Art

Semiconductor memory devices may be divided into volatile memory devices (e.g., DRAM, SRAM, etc.) and nonvolatile memory devices (e.g., EEPROM, FRAM, PRAM, MRAM, etc.). While the volatile memory devices lose stored data at power-off, the nonvolatile memory devices may retain stored data even at power-off. In particular, a flash memory may have advantages such as a fast programming speed, a low power, a mass data storage capacity, and so on. Hence, a flash memory-based data storage device may be widely used.

Flash memory-based data storage devices may include a solid state drive (SSD) replacing a conventional hard disk drive, a memory card such as an SD card or a multimedia card (MMC), and so on. Since such a semiconductor memory device becomes compact, it may be embedded in a portable electronic device. For example, embedded memory devices may include eSSD (embedded SSD), eMMC (embedded MMC), and so on. The eSSD may be applied to a laptop computer, a tablet PC, or an e-book. The eMMC may be applied to a mobile device.

### SUMMARY OF THE INVENTION

One aspect of embodiments of the inventive concept is directed to provide a memory system which comprises a storage device including a flash memory; and a host configured to request a storage device state and user pattern information via a user interface, to analyze the user pattern information, to set up a parameter of the storage device such that the storage device operates an optimization operation, according to the analyzing result, and to provide a command for the optimization operation to the storage device.

In example embodiments, the storage device state is at least one of a P/E cycle and a background operation state. The user pattern information is at least one of the amount of data written, a memory access type, and a memory access time. The host calculates an expected value of lifetime of the storage device using the P/E cycle and provides the calculated result to a user. The host provides the user with a recommend level for the optimization operation of the storage device.

In other example embodiments, the user interface is an application. The host informs a user of a progress state of the storage device via the application and guides an operation setup on the storage device.

In still other example embodiments, the host performs self-diagnosis and self-healing operations on the storage device. The self-healing operation is accomplished by switching hot data and cold data, performing a data reclaim operation, controlling an over-provisioning area, changing a parameter, or by changing a program condition.

Another aspect of embodiments of the inventive concept is directed to provide an operating method of a mobile device which includes a storage device and a host. The operating method comprises requesting a storage device state and user pattern information via a user interface; analyzing the user pattern information; setting up a parameter of the storage device such that the storage device operates an optimization operation, according to the analyzing result; and providing a command for the optimization operation to the storage device.

The operating method further comprises providing a recommend level for the optimization operation to a user. The operating method further comprises informing a user of a progress state of the storage device via the application; and guiding an operation setup on the storage device. The operating method further comprises calculating an expected value of lifetime of the storage device using the P/E cycle to provide the calculated result to a user. The operating method further comprises performing self-diagnosis and self-healing operations on the storage device.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a block diagram schematically illustrating a memory system according to an embodiment of the inventive concept.

FIG. 2 is a block diagram illustrating a memory system according to an embodiment of the present general inventive concept.

FIG. 3 illustrates a user interface of a configuration controller of a memory system according to an embodiment of the present general inventive concept.

FIGS. 4 to 8 are diagrams illustrating a method of a memory system according to an embodiment of the present general inventive concept.

FIG. 9 is a block diagram illustrating a memory system according to an embodiment of the present general inventive concept.

FIG. 10 is a block diagram schematically illustrating a memory system according to an embodiment of the inventive concept.

FIG. 11 is a diagram schematically illustrating a software layer structure of a memory system of FIG. 10.

FIG. 12 is a flow chart schematically illustrating a user pattern-based dynamic parameter control method of a memory system of FIG. 10.

FIG. 13 is a flow chart schematically illustrating a user-specific parameter guide method of a memory system of FIG. 10.

FIG. 14 is a diagram schematically illustrating a self-diagnosis and self-healing operation of a memory system of FIG. 10.

FIGS. 15 and 16 are timing diagrams illustrating a method in which the performance of a storage device is improved via a control of a garbage collection operation.

FIG. 17 is a graph for describing an application installing operation.

FIG. 18 is a flow chart schematically illustrating an application installing operation.

FIG. 19 is a graph for describing a method of deciding a performance enhancement level of a storage device via UI setup of a user.

FIG. 20 is a diagram schematically illustrating UI setup of a user.

FIG. 21 is a flow chart schematically illustrating a loop operation of a memory system of FIG. 10.

FIG. 22 is a block diagram schematically illustrating a mobile device including a memory system according to an embodiment of the inventive concept.

FIG. 23 is a diagram schematically illustrating a software layer structure of a mobile device of FIG. 22.

FIG. 24 is a flow chart schematically illustrating a method in which a mobile device performs a garbage collection operation via an application.

FIG. 25 is a block diagram illustrating a memory system according to an embodiment of the present general inventive concept.

FIG. 26 is a block diagram illustrating an application example of the memory system of FIG. 25.

FIG. 27 is a block diagram illustrating a computing system including the memory system of FIG. 26.

### DETAILED DESCRIPTION OF THE PREFERRED EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

The term “unit” or “module”, as used herein, means, but is not limited to, a software or hardware component, such as a field programmable gate array (FPGA) or an application specific integrated circuit (ASIC), which performs certain tasks. A unit or module may advantageously be configured to reside in the addressable storage medium and configured to execute on one or more processors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

I. Memory System Controlling Storage Device Via User Interface

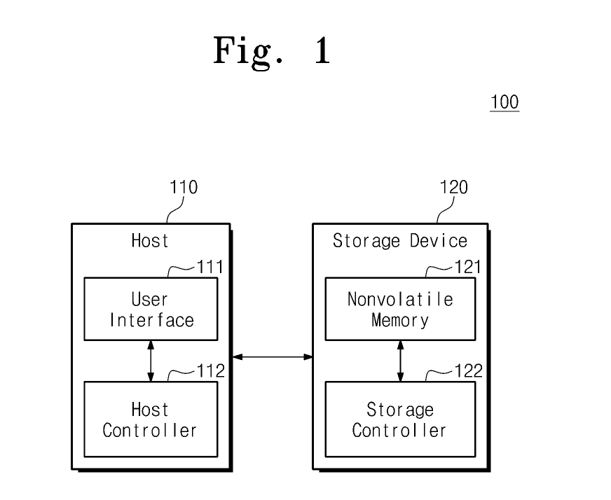

FIG. 1 is a block diagram schematically illustrating a memory system according to an embodiment of the inventive concept. Referring to FIG. 1, a memory system 100 may include a host 110 and a storage device 120. The host 110 may include a user interface 1111 and a host controller 112, and the storage device 120 may include a nonvolatile memory 121 and a storage controller 122.

The memory system 100 may be configured to control an operating characteristic of the storage device 120 or perform an optimization operation via the user interface 1111. For example, the memory system 100 may provide a user with information associated with a state of a storage device, a user pattern, predicted lifetime, optimization of a storage device, OS optimization, firmware update, initialization of a storage device, etc. via the user interface 1111, and may control the storage device 120 according to a demand of a user.

The memory system 100 may be applied to a variety of user devices. For example, the inventive concept may be applied to a computer or a tablet PC which uses a solid state drive (SSD) as its storage device. Also, the inventive concept may be applied to a mobile device which uses a memory card such as an embedded multi-media card (hereinafter, referred to as eMMC) or a micro SD card as its storage device.

Below, there will be described a method of improving the performance and reliability of a storage device by adjusting an operating characteristic of a storage device or performing an optimization operation via a user interface.

II. Operating Characteristic Controlling Method of Storage Device Using User Interface

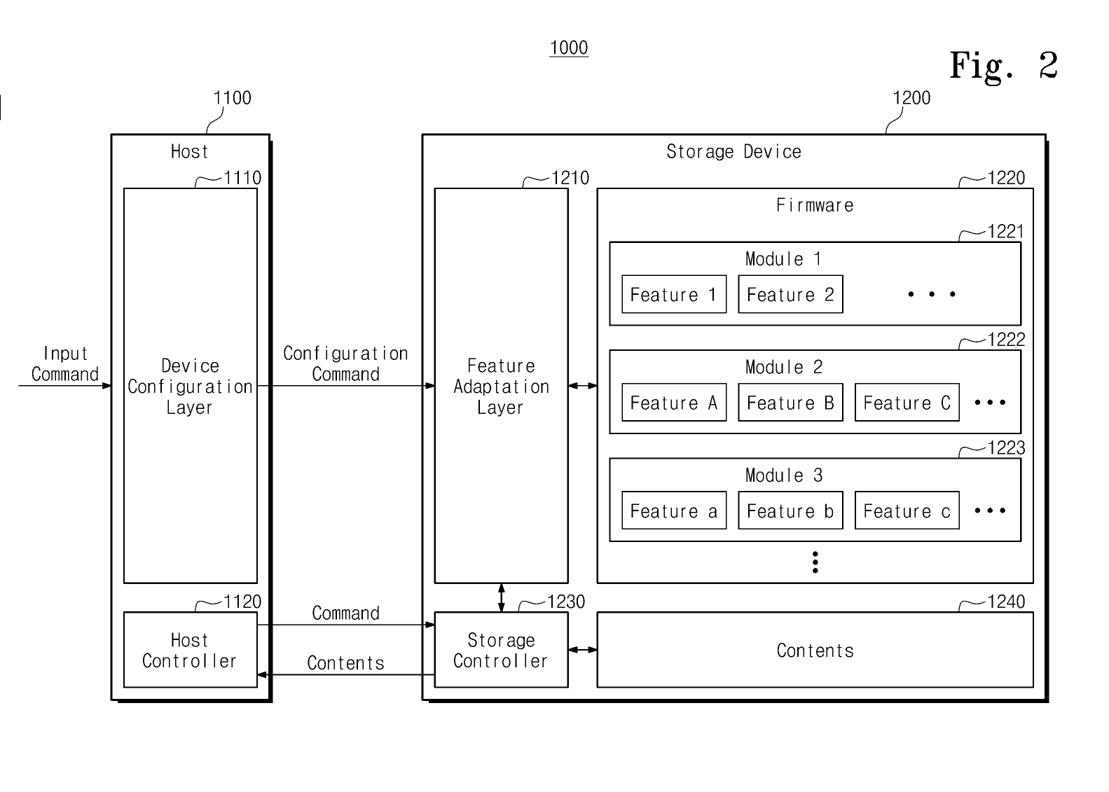

FIG. 2 is a block diagram illustrating a memory system according to an embodiment of the present general inventive concept.

Referring to FIG. 2, the memory system 1000 may include a host 1100 and a storage device 1200.

The host 1100 may include, as illustrated in FIG. 2, a configuration controller (or device configuration layer) 1110 and a host controller 1120.

The configuration controller 1110 may receive an input command and output a configuration command corresponding thereto. Here, the input command may be a command for controlling the operating characteristics of the storage device 1200 according to the use environment. The input command may be provided from an outside thereof. For example, the input command may be inputted from a user through a user interface (UI) or the like included in the configuration controller 1110. The user interface may be an input unit connected to the configuration controller 1110 such that the user can input the input command. The user interface may be a screen of a display unit, for example, a touch panel, such that the user interface is generated from the configuration controller 1110 and is displayed on a display unit connected to the host 1100 such that the user can input the user command through the touch panel of the display unit.

The host controller 1120 may output a command associated with a content read/write operation to a storage controller 1230 to allow the host 1100 to process contents stored in the storage device 1200 or store new contents in the storage device 1200. Here, the processing the contents in the host 1100 may be referred to as displaying or printing the contents in the form of image and document, playing back the contents in the form of audio and/or video, and installing or executing the contents in the form of application such as computer program. Here, the host may have a functional unit (not illustrated) to perform the processing operation of the host 1100. It is possible that the functional unit may have a mechanical structure and/or an electrical circuit element to perform the processing operation as described above.

The storage controller 1230 receives the command associated with the contents from the host controller 1120 and controls contents 1240 stored in the storage device 1200 according to the received command. For example, when the received command is a read command, the storage controller 1230 may provide the contents 1240 stored in the storage device 1200 to the host 1100, and when the received command is a write command, the storage controller 1230 may receive new contents from the host 1100 and store the received contents in the storage device 1200.

Although FIG. 2 illustrates the configuration controller 1110 and the host controller 1120 as separate units, the present general inventive concept is not limited thereto. For example, the configuration controller 1110 and the host controller 1120 may be implemented as one integrated unit in the host 1100 if necessary.

The storage device 1200 may include an adaptation controller (or feature adaption layer) 1210 and the storage controller 1230. The storage device 1200 may store firmware 1220 and the contents 1240. Here, the firmware 1220 may be installed in the storage device 1200 to drive the storage device 1200. The contents 1240 may be stored in a separate memory area (not illustrated) included in the storage device 1200.

Referring to FIG. 2, the firmware 1220 may include a plurality of modules 1221, 1222 and 1223. Each of the modules 2121, 1222 and 1223 may perform each function associated with the corresponding operation of the storage device 1200. For example, a first module 1221 may be a module associated with a read/write operation of the storage device 1200, a second module 1222 may be a module associated with an operating frequency of the storage device 1200, and a third module 1223 may be a module associated with a garbage collection of the storage device 1200. In addition, the storage device 1200 may further include a plurality of modules associated with operational functions of the storage device 1200.

Meanwhile, each of the modules 1221, 1222 and 1223 may include a plurality of features. Here, one feature may be a group of small units constituting the firmware 1220, and various features may be combined to implement one functional unit module 1221, 1222 or 1223.

For example, when the first module 1221 is a module associated with the read/write operation of the storage device 1200, the first module 1221 may include a first feature (FEATURE 1) to preferentially process a read command over a write command among the commands received from the host 1100, and a second feature (FEATURE 2) to preferentially process a write command over a read command among the commands received from the host 1100.

The read command may have a higher priority than that of the write command in the first feature (FEATURE 1) such that the firmware 1220 may process the read command having a higher priority before processing the write command or such that the write command may not interfere with the processing of the read command. The write command may have a higher priority than that of the reading command in the second feature (FEATURE 2) such that the firmware 1220 may process the write command having a higher priority before processing the read command or such that the read command may not interfere with the processing of the write command.

The term of “preferentially process a command” may be referred to as “process a command having a higher priority,” “process a command without being interrupted by other commands,” “process a command by interrupting other command,” “process a command by delaying processing of other commands,” “delay other commands until a command is completed,” or “not generating other commands when a command is generated,” for example.

Further, when the second module 1222 is a module associated with the operating frequency of the storage device 1200, the second module 1222 may include a third feature (FEATURE A) to drive the storage device 1200 at a low frequency (e.g., low clock frequency), a fourth feature (FEATURE B) to drive the storage device 1200 at a high frequency (e.g., high clock frequency), and a fifth feature (FEATURE C) to drive the storage device 1200 at a configuration frequency received from the host 1100.

Further, when the third module 1223 is a module associated with the garbage collection of the storage device 1200, the third module 1223 may include a sixth feature (FEATURE a) to allow the storage device 1200 to perform garbage collection, a seventh feature (FEATURE b) to stop the garbage collection of the storage device 1200, and an eighth feature (FEATURE c) to allow the storage device 1200 to perform garbage collection at a configuration frequency received from the host 1100.

Whether or not to enable each feature is determined by the adaptation controller 1210. The adaptation controller 1210 may receive a configuration command from the configuration controller 1110 of the host 1100 and enable a feature corresponding to the configuration command.

When the corresponding feature is enabled according to the configuration command, operating characteristics of the storage device 1200 can be set or determined. Thus, the storage controller 1230 sends/receives the contents 1240 to/from the host 1100 while driving the storage device 1200 according to the set characteristics.

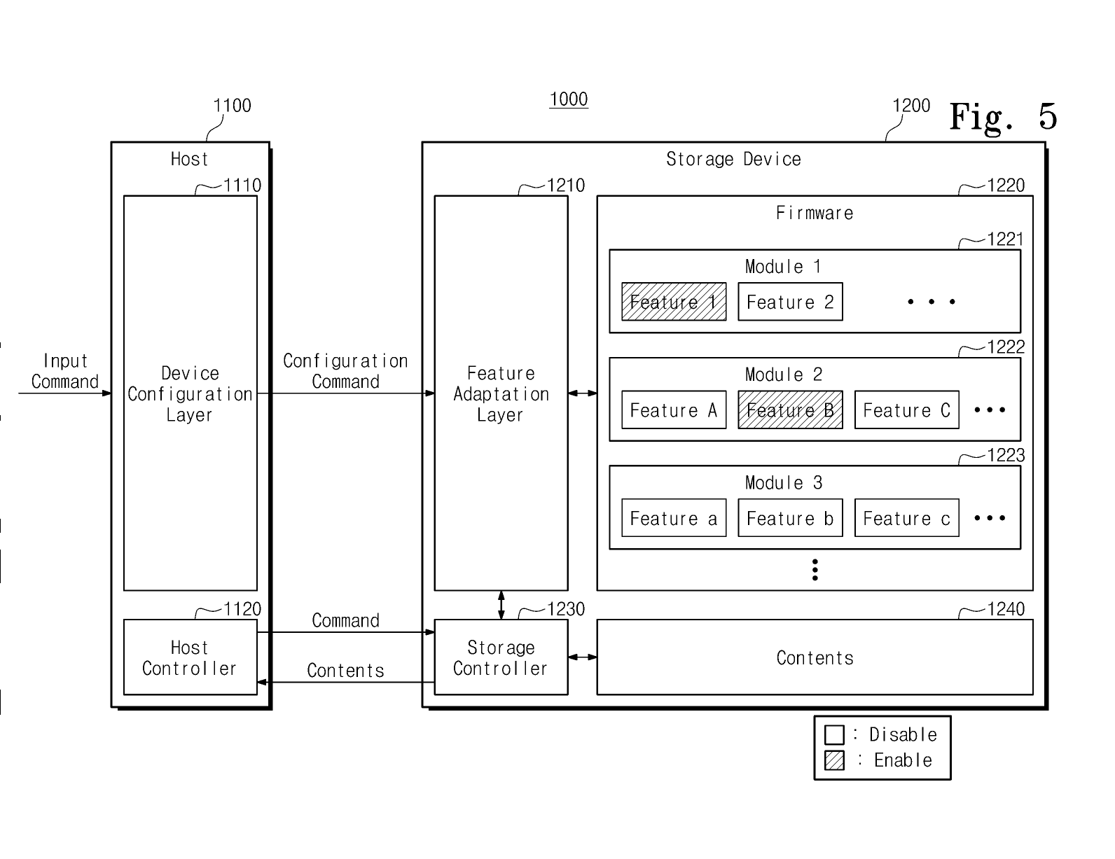

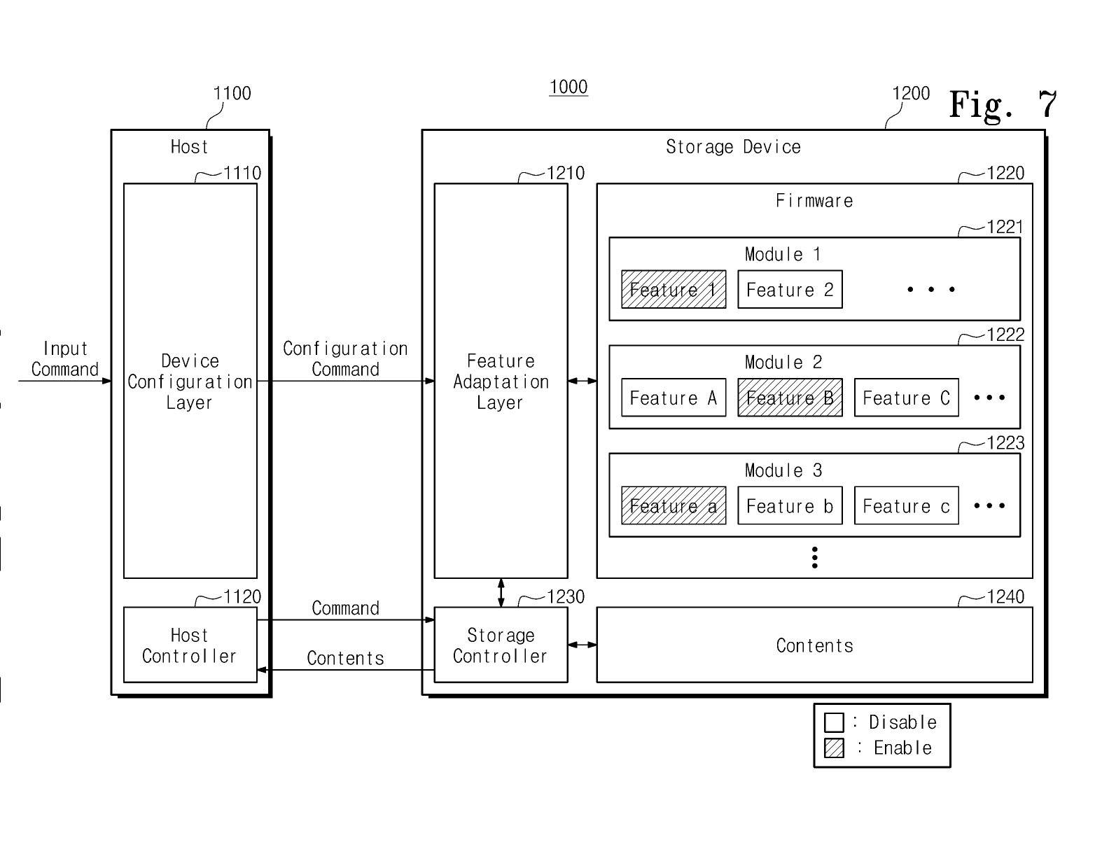

Hereinafter, an operation of a memory system according to an embodiment of the present general inventive concept will be described in detail with reference to FIGS. 2 to 7.

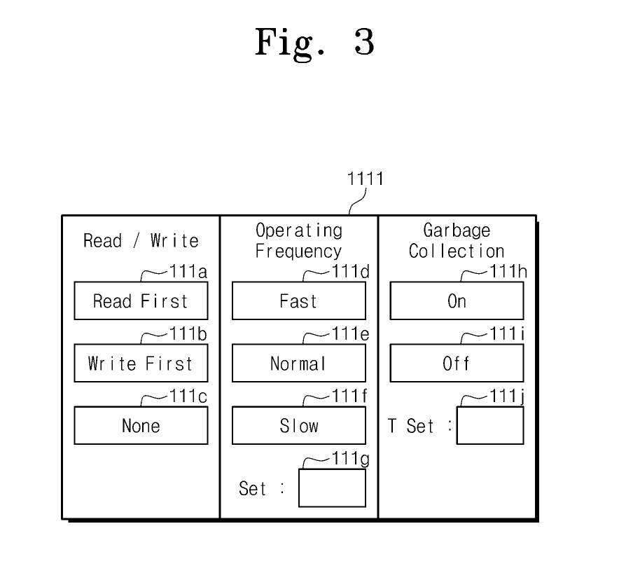

FIG. 3 illustrates a user interface 1111 included in the configuration controller 1110 of FIG. 2. FIGS. 3 to 7 are diagrams illustrating an operation of the memory system of FIG. 2 according to an embodiment of the present general inventive concept.

As described above, the configuration controller 1110 of the host 1100 may include the user interface 1111 to receive the input command from the user. The user interface 1111 of FIG. 3 is one example of the user interface of the configuration controller 1110 of FIG. 2.

Referring to FIG. 3, the user interface 1111 may include a first button 111a to generate a configuration command such that the storage device 1200 preferentially processes a read command over a write command, a second button 111b to generate a configuration command such that the storage device 1200 preferentially processes a write command over a read command, and a third button 111c to generate a configuration command such that the storage device 1200 processes read and write commands without setting a priority thereon.

There are one or more different categories in the contents 1240. When the contents 1240 stored in the storage device 1200 are one category, for example, e-books, the host 1100 may send more read commands than write commands to the storage device 1200 during performing the operation on the e-books. Accordingly, in this use environment, the storage device 1200 is required to preferentially process a read command over a write command. In this case, the user may enable the first button 111a included in the user interface 1111 to generate a configuration command such that the storage device 1200 preferentially processes a read command over a write command.

It is possible that the host 1100 automatically controls the user interface 1111 to select the first button 111a to generate a read command more than a write command such that a user does not have to manually enable the first button 111a when the category, that is the e-books, is selected by the user. This may be applied to other categories of the contents 1240 or user environments hereinafter.

Although not illustrated, the host 1100 may have another user interface such that the user can select one of the categories of the contents 1240. According to the user selection through the another user interface, the host 1100 may perform an operation associated with the selected category of the contents 1240. This may also be applied to other categories of the contents 1240 or user environments hereinafter.

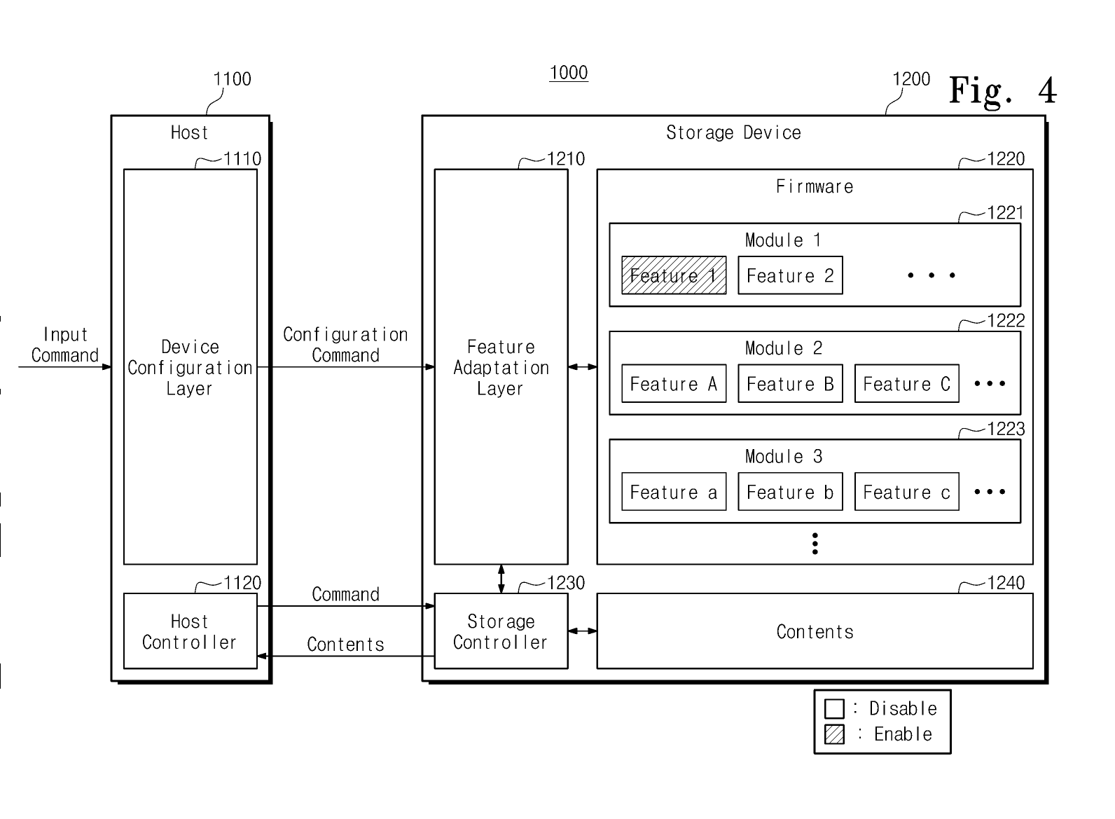

Referring to FIG. 4, the generated configuration command is provided to the adaptation controller 1210, and the adaptation controller 1210 enables the first feature (FEATURE 1) of the first module 1221 included in the firmware 1220. In this case, the adaptation controller 1210 may disable the second feature (FEATURE 2) for preferentially processing a write command over a read command.

When the contents 1240 stored in the storage device 1200 are another category, for example, documents or word processing documents, the host 1100 may send more write commands than read commands to the storage device 1200 during performing the operation on the documents. In this case, the user may enable the second button 111b, and the adaptation controller 1210 may enable the second feature (FEATURE 2) and disable the first feature (FEATURE 1) of the first module 1221 through a process similar to that as described above.

When the read operation and the write operation are expected to be balanced or equally performed in view of the characteristics of the contents 1240 stored in the storage device 1200, the user may enable the third button 111c, and the adaptation controller 1210 may enable or disable both the first feature (FEATURE 1) and the second feature (FEATURE 2) through a process similar to that as described above.

Referring back to FIG. 3, the user interface 1111 may include a fourth button 111d to generate a configuration command such that the storage device 1200 is driven at a first frequency, a fifth button 111e to generate a configuration command such that the storage device 1200 is driven at a second frequency lower than the first frequency, and a sixth button 111f to generate a configuration command such that the storage device 1200 is driven at a third frequency lower than the second frequency. Further, the user interface 1111 may additionally include a first input section 111g to allow the user to directly input a desired configuration frequency.

When a state of the storage device 1200, for example, a drive environment of the storage device 1200, is a high temperature environment, when the storage device 1200 is continuously driven at a high frequency, the performance of the storage device 1200 may deteriorate. Accordingly, in this case, the user may enable the sixth button 111f included in the user interface 1111 to generate a configuration command such that the storage device 1200 is driven at different driving frequency, for example, at a relatively low driving frequency.

Referring to FIG. 3, the generated configuration command is provided to the adaptation controller 1210, and the adaptation controller 1210 may enable the fourth feature (FEATURE B), and disable the third feature (FEATURE A) of the second module 1222 included in the firmware 1220.

On the other hand, when the drive environment of the storage device 1200 is a low temperature environment, the storage device 1200 is required to be driven at a high frequency to generate heat to thereby maintain the performance of the storage device 1200. In this case, the user may enable the fourth button 111d included in the user interface 1111, thereby disabling the fourth feature (FEATURE B) and enabling the third feature (FEATURE A). When there is no need to separately set the driving frequency of the storage device 1200, the user may enable the fifth button 111e included in the user interface 1111, thereby disabling or enabling both the third feature (FEATURE A) and the fourth feature (FEATURE B).

Further, when the user intends to manually set the driving frequency of the storage device 1200, the user may input a configuration frequency to the first input section 111g included in the user interface 1111 to thereby generate a configuration command such that the storage device 1200 is driven at the configuration frequency.

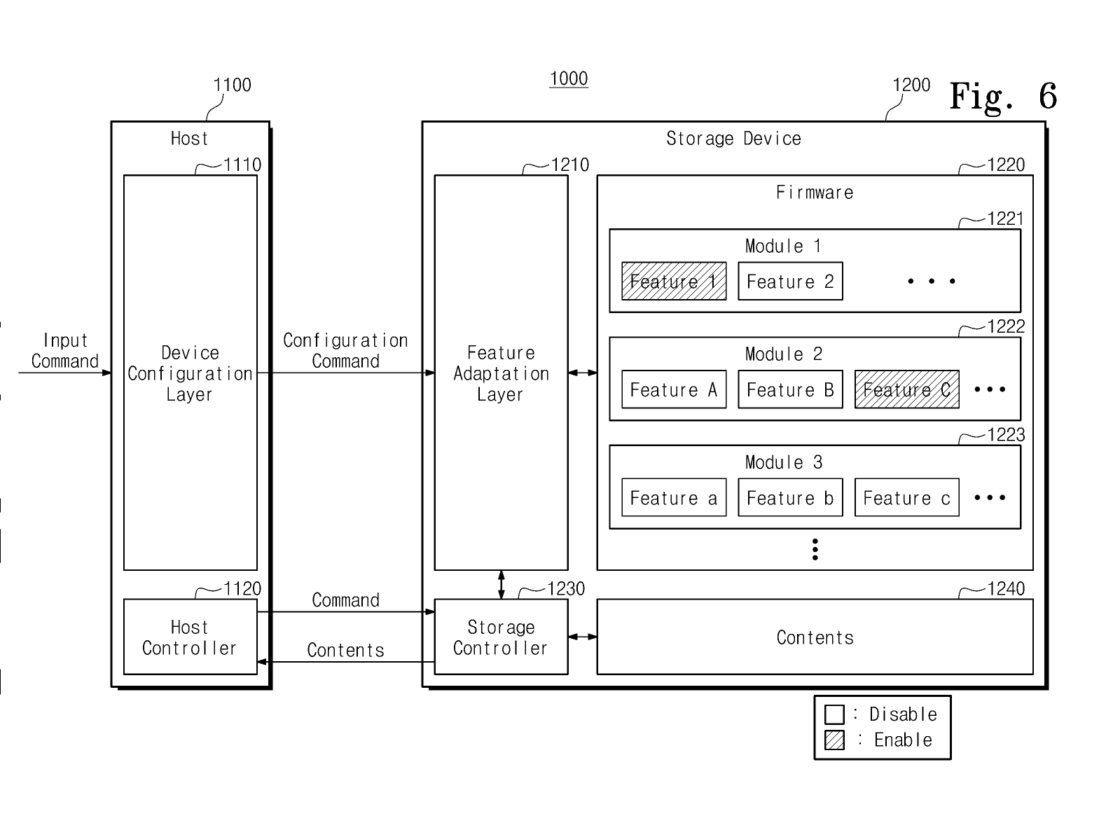

Referring to FIG. 6, the generated configuration command is provided to the adaptation controller 1210, and the adaptation controller 1210 may enable the fifth feature (FEATURE C) of the second module 1222 included in the firmware 1220. In this case, the storage device 1200 is driven at the configuration frequency received from the host 1100.

Referring again back to FIG. 3, the user interface 1111 may include a seventh button 111h to generate a configuration command such that the storage device 1200 performs a garbage collection, and an eighth button 111i to generate a configuration command such that the storage device 1200 does not perform the garbage collection. Further, the user interface 1111 may additionally include a second input section 111j to allow the user to directly input a desired garbage collection cycle.

If the state of the storage device 1200 requires a garbage collection, the user may enable the seventh button 111h included in the user interface 1111 to generate a configuration command such that the garbage collection is performed in the storage device 1200.

Referring to FIG. 6, the generated configuration command is provided to the adaptation controller 1210, and the adaptation controller 1210 may enable the sixth feature (FEATURE a) and disable the seventh feature (FEATURE b) of the third module 1223 included in the firmware 1220.

When the state of the storage device 1200 requires no garbage collection, the user may enable the eighth button 111i included in the user interface 1111, thereby disabling the sixth feature (FEATURE a) and enabling the seventh feature (FEATURE b). It is possible that the host 1100 or the storage device 1200 may automatically enable the eighth button 111i according to the state of the storage device 1200.

Further, when the user intends to manually set a garbage collection cycle of the storage device 1200, the user may input a configuration cycle to the second input section 111j included in the user interface 1111 to thereby generate a configuration command such that the storage device 1200 performs a garbage collection according to the configuration cycle.

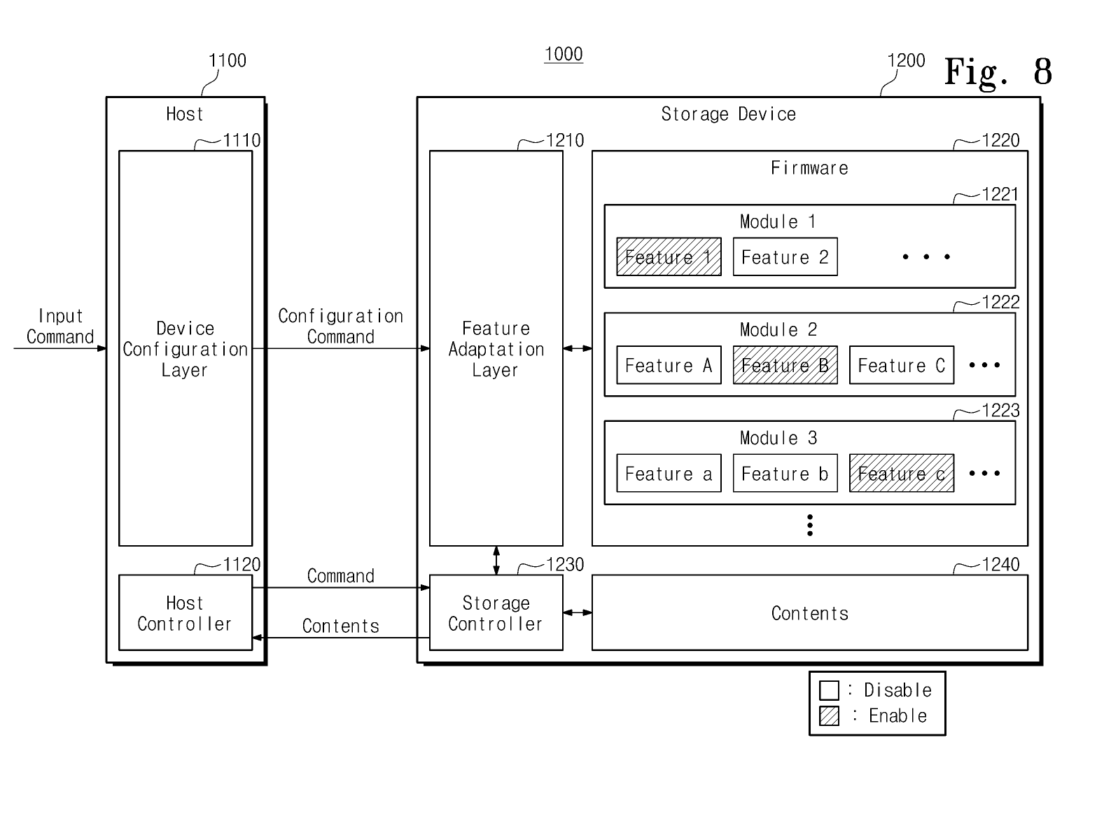

Referring to FIG. 8, the generated configuration command is provided to the adaptation controller 1210, and the adaptation controller 1210 may enable the eighth feature (FEATURE c) of the third module 1223 included in the firmware 1220. In this case, the storage device 1200 performs the garbage collection in the configuration cycle received from the host 1100.

Although the operation of the memory system according to an embodiment of the present general inventive concept has been described using the exemplary functions of some features, the present general inventive concept is not limited thereto. The operation of the memory system according to embodiment of the present general inventive concept can be extended to other operations than the above-described examples. Further, although the user interface 1111 that can be included in the configuration controller 1110 has been illustrated as an example in FIG. 3, the user interface 1111 can be also modified to provide information associated with the host 1100 and/or the storage device 1200 to the user and/or to provide the command, data, or selection input by the user to the host 1100 and/or the storage device 1200.

Meanwhile, although the input command has been inputted from the user through the user interface 1111 in the above-described examples, it may be also modified such that the host 1100 and the storage device 1200 can perform the operations thereof. For example, the host 1100 or the storage device 1200 may further include a sensor (not illustrated) to sense a state of the storage device 1200 corresponding to one or more operational functions of the storage device 1200 such that the input command is generated from the sensor (not illustrated) and provided to the configuration controller 1110 of the host 1100.

Further, although the adaptation controller 1210 and the storage controller 1230 are illustrated as separate elements, the present general inventive concept is not limited thereto. That is, the adaptation controller 1210 and the storage controller 1230 may be implemented as one integrated unit if necessary.

In this embodiment, the storage device 1200 may be a semiconductor apparatus, for example, a solid state drive (SSD), in which a controller and a non-volatile memory device are integrated into one semiconductor device, but the present general inventive concept is not limited thereto.

Referring again to FIG. 2, the configuration controller 1110 of the host 1100 may provide the configuration command to the adaptation controller 1210 of the storage device 1200 using a first interface. Further, the host controller 1120 of the host 1100 may send/receive the command and the contents to/from the storage controller 1230 of the storage device 1200 using a second interface. The second interface may be generated from the storage controller 1230 of the storage device 1200 and provided to the user such that the command and contents can be input to the storage controller 1230 by the user through the second interface. The second interface may be provided through the host 1100 such that the second interface can be provided to the user in the similar way to the first interface.

In an embodiment of the present general inventive concept, the first interface and the second interface may be different interfaces. For example, any one of the first interface and the second interface may have a short-range wireless communication mode, such as Bluetooth, near field communication (NFC), and radio frequency identification (RFID), and the other one of the first interface and the second interface may have a wired communication mode such as universal serial bus (USB), AT attachment (ATA), and serial ATA (SATA).

However, in an embodiment of the present general inventive concept, the first interface and the second interface may be the same interface. For example, the first interface and the second interface may be serial advanced technology attachment (SATA) interfaces. In this case, the configuration command may be provided from the configuration controller 1110 to the adaptation controller 1210 in the form of a SATA command through the SATA interface.

FIG. 9 is a block diagram illustrating a memory system according to an embodiment of the present general inventive concept.

Referring to FIG. 9, the memory system 2000 may include a host 2100, a first storage 2300 and a second storage 2400. The host 2100 may be configured in the same manner as the host 1100 of FIG. 2. The first and second storages 2300 and 2400 may be also configured in the same manner as the storage device 1200 of FIG. 2. A portion of the configuration of FIG. 2 is omitted in FIG. 9 for convenience of explanation.

A configuration controller (device configuration layer) 2110 of the host 2100 may receive an input command and output a first configuration command (CONFIGURATION COMMAND-1) and a second configuration command (CONFIGURATION COMMAND-2) corresponding thereto. Here, the first configuration command (CONFIGURATION COMMAND-1) may be a command to determine whether to enable each of a plurality of features included in the first storage 2300, and the second configuration command (CONFIGURATION COMMAND-2) may be a command to determine whether to enable each of a plurality of features included in the second storage 2400.

A first adaptation controller (feature adaptation layer) 2310 included in the first storage 2300 may receive the first configuration command (CONFIGURATION COMMAND-1) from the configuration controller 2110 and determine whether to enable each feature (FEATURE 1-4). Further, a second adaptation controller (feature adaptation layer) 2410 included in the second storage 2400 may receive the second configuration command (CONFIGURATION COMMAND-2) from the configuration controller 2110 and determine whether to enable each feature (FEATURE 1-4).

Here, the first configuration command (CONFIGURATION COMMAND-1) and the second configuration command (CONFIGURATION COMMAND-2) may be different from each other according to the environments in which the first storage 300 and the second storage 2400 are operated. Accordingly, as illustrated, the enabled feature (FEATURE 1, 3, 4) of the first storage 2300 may be different from the enabled feature (FEATURE 2) of the second storage 2400.

For example, when the contents stored in the first storage 2300 are one type or category of contents, such as e-books, the first adaptation controller 2310 may enable a first feature (FEATURE 1) and disable a second feature (FEATURE 2) included in a firmware module 2320 according to the first configuration command (CONFIGURATION COMMAND-1). Thus, among the commands inputted to the first storage 2300, a read command may be processed first.

Further, when the contents stored in the second storage 2400 are another type or category of contents, such as word processing documents, the second adaptation controller 2410 may enable a second feature (FEATURE 2) and disable a first feature (FEATURE 1) included in a firmware module 2420 according to the second configuration command (CONFIGURATION COMMAND-2). Thus, among the commands inputted to the second storage 2400, a write command may be processed first.

As described above, the enabled feature (FEATURE 1, 3, 4) of the first storage 2300 and the enabled feature (FEATURE 2) of the second storage 2400 may be modified in any way according to the environments in which the first storage 300 and the second storage 2400 are operated.

III. Optimization Operation Method of Storage Device Using User Interface

A memory system according to an embodiment of the inventive concept may perform an optimization operation on a storage device using a user interface. The inventive concept may analyze a state of a storage device and a user pattern and provide a user with optimization information on the storage device. With the inventive concept, a setup suitable for the user or required by the user may be applied to the storage device, so that the performance, reliability and lifetime of the storage device are improved.

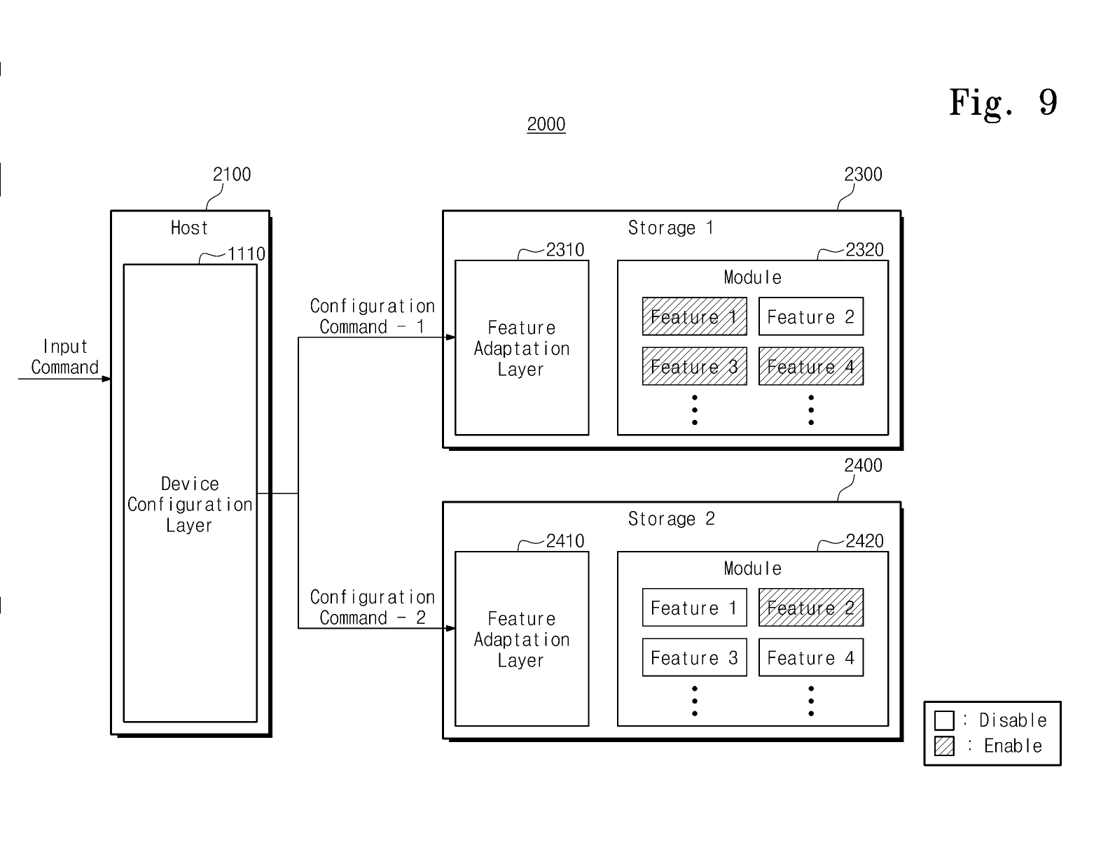

FIG. 10 is a block diagram schematically illustrating a memory system according to an embodiment of the inventive concept. Referring to FIG. 10, a memory system 3000 may include a host 3100 and a storage device 3200. The host 3100 may include a user interface 3110 and an operating system 3120. The operating system 3120 may include a file system 3121, an input/output driver 3122, and so on.

The user interface 3110 may include various application programs executed at the host 3100. For example, the user interface 3100 may be an application. A user may perform functions such as OS optimization, firmware update, initialization of a storage device, adjusting of an over provisioning area, and so on via the application. Also, the user may analyze a state of a storage device and a user pattern via the application.

The operating system 3120 may control software and/or hardware resources of the host 3100, and may manage program execution of a processor (not shown). In the case that files or data are stored at the storage device 3200, the file system 3121 may perform organization and management on the files or data. The input/output driver 3122 may enable the storage device 3200 to operate compatibly with the host 3100.

As a flash memory-based data storage device, the storage device 3200 may include a flash memory 3210 and a storage controller 3220. The storage device 3200 may be an embedded MMC (hereinafter, referred to as eMMC), an embedded SSD (hereinafter, referred to as eSSD), a memory card, an ATA bus device, an SATA bus device, a memory stick device, a hybrid drive device, or a universal serial bus flash memory.

The flash memory 3210 may be connected with a storage controller 3220 via an address/data bus. The flash memory 3210 may perform an erase operation by the memory block and a read or write operation by the page. The flash memory 3210 may include a data area 3211 and a meta area 3212. User data or main data may be stored at the data area 3211, and meta data (e.g., address mapping information) needed to drive the flash memory 3210 other than the user data may be stored at the meta area 3212.

The storage controller 3220 may control read, write and erase operations of the flash memory 3210. The storage controller 3220 may include a CPU and a random access memory. The CPU may drive firmware 3221 using the random access memory. The firmware 3221 may be a combination of software and hardware. The performance of the storage device 3200 may be improved via firmware update.

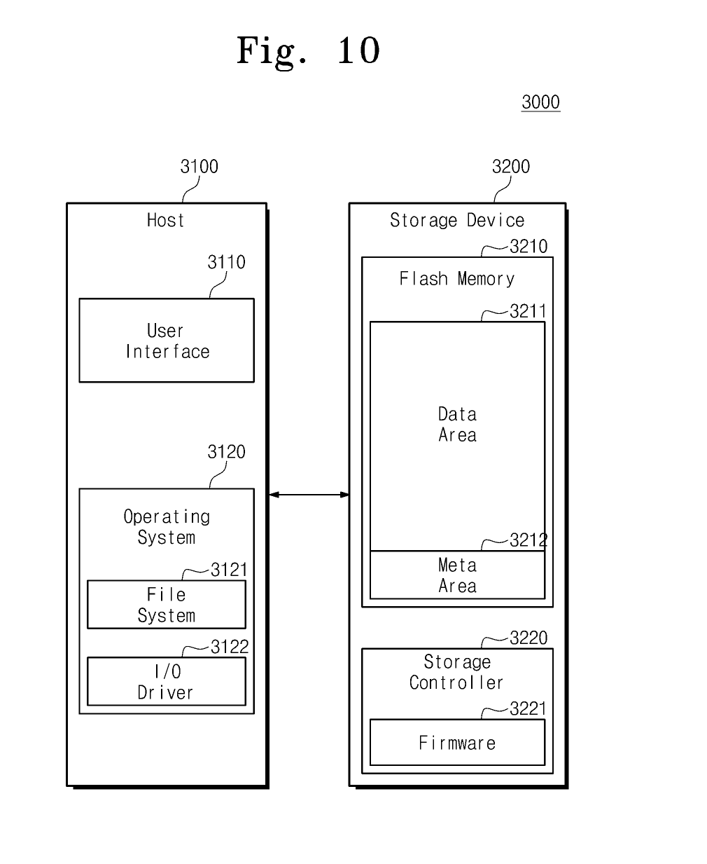

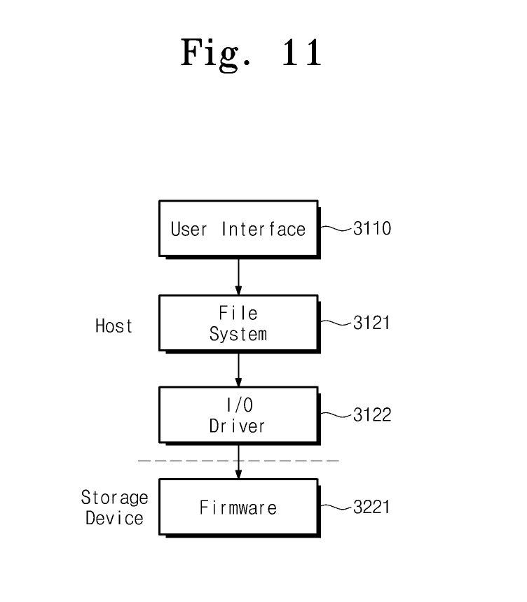

FIG. 11 is a diagram schematically illustrating a software layer structure of a memory system of FIG. 10. Referring to FIG. 11, a memory system 3000 (refer to FIG. 10) according to an embodiment of the inventive concept may have a software layer structure which is formed of a user interface 3110, a file system 3121, an input/output driver 3122, and firmware 3221.

Herein, the user interface 3110, the file system 3121, and the input/output driver 3122 may be driven at a host 3100, and the firmware 3221 may be driven at a storage device 3200. The firmware 3221 may be stored at an area (e.g., a meta area) of a flash memory 3210, and may be loaded on a random access memory of the storage device 3200 during driving. The firmware 3221 can be loaded on the host 3100 according to the storage device 3200.

A user may issue a command (hereinafter, referred to as an optimization command) for an optimization operation to the storage device 3200 via the user interface 3110. The user interface 3110 may request the optimization command at the input/output driver 3122, and the input/output driver 3122 may send the optimization command to the firmware 3221 of the storage device 3220. When analysis of a user pattern is required, the user interface 3110 may request it at an operating system 3120 to collect the user pattern. When state information of the storage device 3200 is required, the input/output driver 3122 may request it at the firmware 3221 of the storage device 3200 to collect data.

The memory system 3000 of the inventive concept may collect a state of a storage device and a user pattern via the user interface 3110, and may issue an optimization command to the storage device 3200. The inventive concept may control the storage device 3200 based on information obtained by analyzing the user pattern. The performance and reliability of the storage device 3200 may be improved by applying the setup suitable for a user or required by the user to the storage device 3200.

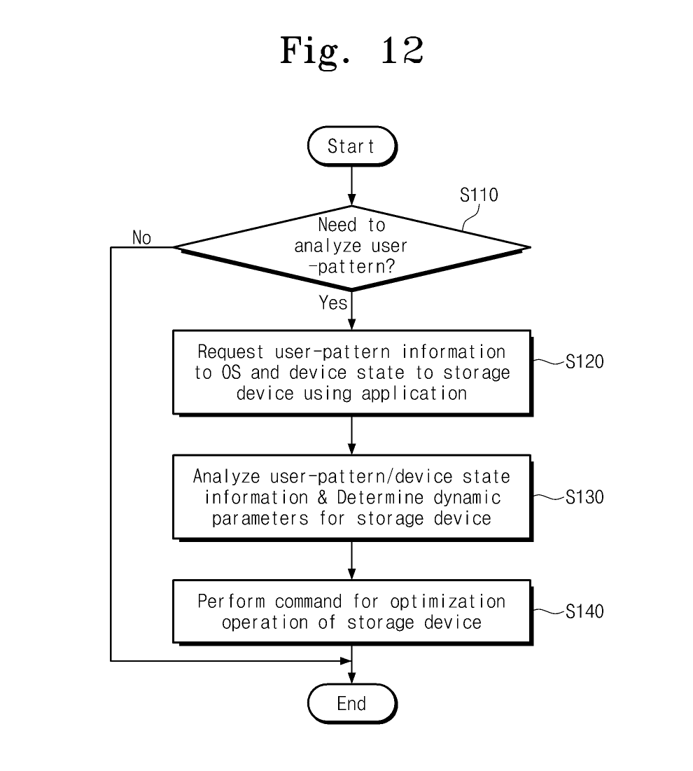

The memory system 3000 according to the inventive concept may improve the performance and reliability of the storage device 3200 via an optimization operation such as user pattern-based dynamic parameter control, user-specific parameter guide, and self-diagnosis and self-healing. A method of performing the optimization operation of the memory system 3000 will be more fully described with reference to FIGS. 12 to 15.

FIG. 12 is a flow chart schematically illustrating a user pattern-based dynamic parameter control method of a memory system of FIG. 10. With a user pattern-based dynamic parameter control method, a memory system 3000 may analyze user pattern information (e.g., the amount of a memory used, a memory access type, or an access time), decide parameter or setup values needed for an optimization operation of a storage device 3200, and provide the decided parameter or setup values to the storage device 3200.

In operation S110, whether an analysis of a user pattern is required may be determined. For example, a user or the memory system 3000 may determine whether an analysis of a user pattern is required. If an analysis of a user pattern is not required, the method may be ended. If an analysis of a user pattern is required, the method proceeds to operation S120.

In operation S120, storage device state information (e.g., P/E cycle information) of a storage device may be requested at the storage device 3200 via a user interface 3110 (or, an application), and user pattern information may be requested at an operating system 3120. That is, in the case that an analysis on a user pattern and a state of a storage device is required, the user pattern information and the storage device state information may be requested at an input/output driver 3122 and firmware 3221.

Herein, the user pattern information may mean a memory use history of a user such as memory usage, a memory access type, a memory access time, and so on, and the storage device state information may mean P/E cycle information.

In operation S130, dynamic parameters of the storage device 3200 may be decided by analyzing the user pattern information and the storage device state information. Herein, the dynamic parameters may be a setting value needed for the storage device 3200 to perform an optimization operation. For example, the dynamic parameters may include a garbage collection level, a wear-leveling level, an allowable lifetime range, and so on.

Garbage collection may be performed to obtain a free block in a flash memory 3210. The flash memory 3210 may operate efficiently at a state in which it is organized by a basic storage unit (e.g., by the memory block or page). However, if the flash memory 3210 is erased or is programmed with various sizes of data during a long time, a data storage space may be fragmented. Thus, it is possible to obtain a free block of the flash memory 3210 through the garbage collection (e.g., collecting of valid data and erasing of invalid data). The garbage collection level may mean an execution frequency of a garbage collection operation or the number of free blocks to be obtained.

Wear-leveling may enable the whole memory blocks to experience an erase operation uniformly to prevent a specific memory block of the flash memory 3210 from being worn out faster than other memory blocks. Lifetime of the storage device 3200 may be lengthened via the wear-leveling. The wear-leveling level may mean an execution frequency of a wear-leveling operation.

The allowable lifetime range may indicate an expected value of lifetime of the flash memory 3210. The storage device 3200 may have an expected value of lifetime to secure the reliability of the user, and the expected value of lifetime may be decided by analyzing the user pattern and the storage device state.

In operation S140, a host 3100 may issue an optimization command to the storage device 3200, and the storage device 3200 may perform an optimization operation. Herein, the optimization operation of the storage device 3200 may mean a garbage collection operation, a wear-leveling operation, a firmware setup value adjusting operation, and so on. The performance and reliability of the storage device 3200 may be improved through the optimization operation.

The memory system 3000 according to an embodiment of the inventive concept may improve the performance and reliability of the storage device 3200 by analyzing user pattern information (e.g., usage, an access type, and an access time), deciding setup values needed for an optimization operation of the storage device 3200, and providing the setup values decided to the storage device 3200.

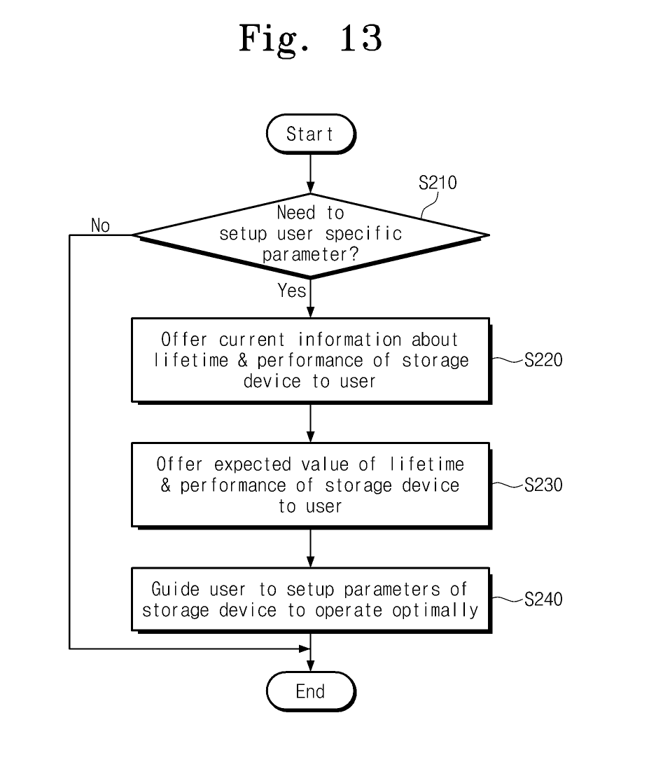

FIG. 13 is a flow chart schematically illustrating a user-specific parameter guide method of a memory system of FIG. 10. With a user-specific parameter guide method, a memory system 3000 may enable a user to use a storage device 3200 at an optimal condition by providing the performance and an expected value of lifetime of the storage device 3200 to the user.

In operation S210, whether setting on a user-specific parameter is required may be determined. For example, a user or the memory system 300 may decide whether setting on a user-specific parameter is required. If setting on a user-specific parameter is not required, the method may be ended. If setting on a user-specific parameter is required, the method proceeds to operation S220.

In operation S220, current state information associated with the lifetime and performance of the storage device 3200 may be provided to a user via a user interface 3110. The memory system 3000 may analyze history data associated with the lifetime and performance of the storage device 3200 to provide the user with the current state information of the storage device 3200.

In operation S230, a variation in the lifetime and performance of the storage device 3200 according to setup of the user may be predicted via the user interface 3110, and an expected value of lifetime may be provided to the user. The memory system 3000 may provide the user with an expected value on a variation in the lifetime or performance together with the current state information associated with the lifetime or performance of the storage device 3200.

In operation S240, the memory system 3000 may guide the user to set up parameters of the storage device 3200 such that the storage device 3200 operates at an optimal condition, via the user interface 3110.

The memory system 3000 may inform the user of a recommend level at which the storage device 3200 optimally operates according to current and expected state information of the storage device 3200. The user may decide an operation of the storage device 3200 in a direction the user wants, based on the recommend level. For example, it is possible to set a warranty period of the storage device 3200 or execution frequency and time of garbage collection.

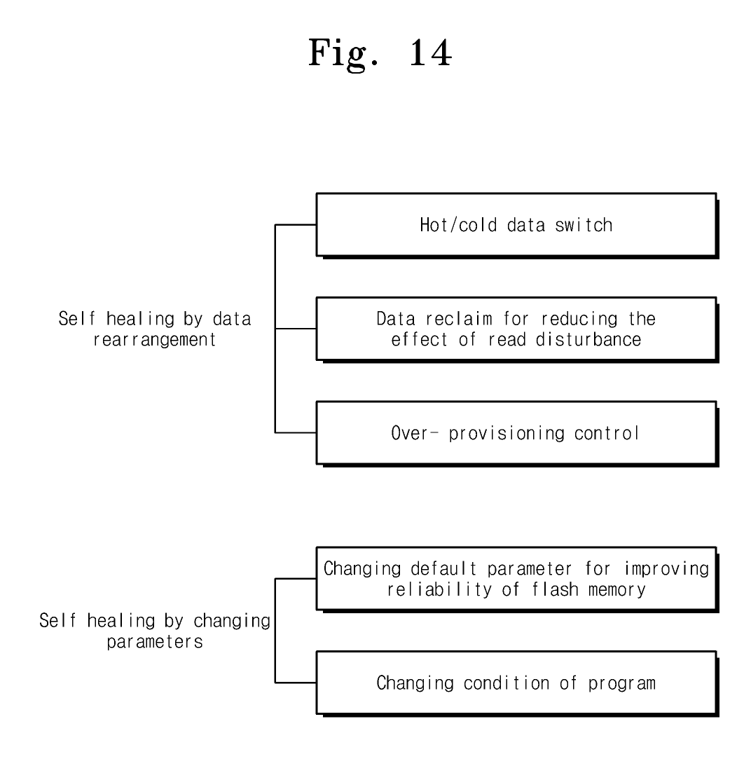

FIG. 14 is a diagram schematically illustrating a self-diagnosis and self-healing operation of a memory system of FIG. 10. With a self-diagnosis and self-healing operation, when the performance and reliability are lowered due to many data input/output on a storage device 3200, a memory system 3200 may issue a command to the storage device 3200 to perform operations of self-diagnosing such a state and self-healing the reliability.

In FIG. 14, there is exemplarily illustrated a self-healing method. The performance of the storage device 3200 may be self-healed through various methods. In FIG. 14, self-healing by data rearrangement and self-healing by changing parameters are exemplarily illustrated.

The self-healing by data rearrangement may include hot/cold data switch for changing locations of hot data (e.g., frequently accessed data) and cold data (e.g., occasionally accessed data), data reclaim for preventing an error from affecting a periphery by changing a location of data at which an error is generated, and over-provisioning for securing a reserved space provided to firmware by adjusting a size of a usable space of the user, and so on.

The self-healing by changing parameters may include changing of a default parameter for changing a read level necessary to divide a physical state of data into “1” and “0”, changing of a program condition of data, and so on.

The memory system 3000 according to the inventive concept may set or change a self-healing method via a user interface 3110. For this, the user interface 3110 of the inventive concept may include a mode for the hot/cold data switch, the data reclaim, the over-provisioning, the changing of the default mode, and the changing of the program condition of data.

As described above, the memory system 3000 according to an embodiment of the inventive concept may provide an application type of service for improving the performance and reliability of the storage device 3200, and may perform functions such as OS optimization, firmware update, initialization of a storage device, adjusting of an over-provisioning area, and so on. Also, the storage device 3200 of the inventive concept may be managed in view of user's intention and a user pattern and a storage device state other than a benchmarking result.

Works such as garbage collection, wear-leveling, adjusting of a firmware setup value, etc. may be utilized to perform an optimization operation on the storage device 3200. Also, it is possible to provide a user with information associated with a work progress state and an expected effect after work execution.

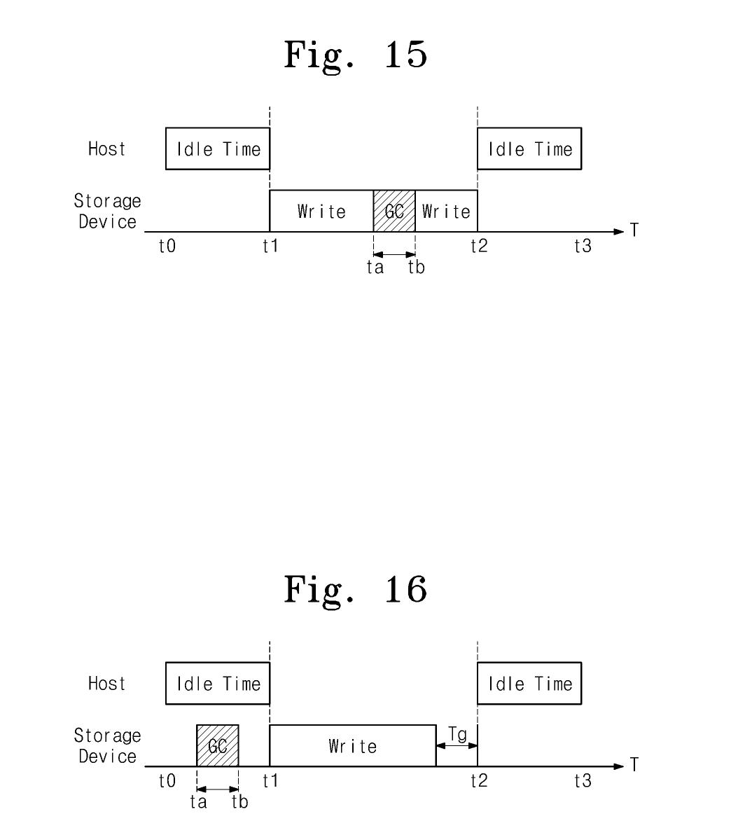

FIGS. 15 and 16 are timing diagrams illustrating a method in which the performance of a storage device is improved via a control of a garbage collection operation. In FIGS. 15 and 16, a period of time t1 to t2 may correspond to a write time when data is stored at a storage device 3200. Periods of time t0 to t1 and t2 to t3 may correspond to an idle time.

In FIG. 15, there is illustrated an example in which firmware of the storage device 3200 performs garbage collection automatically. In general, a garbage collection operation may be performed to make free blocks at a write request. If free blocks are insufficient at the write request, the storage device 3200 may perform the garbage collection operation (during a period of time ta to tb) during the write time t1 to t2. This operation may cause lowering of the write performance of the storage device 3200.

In FIG. 16, there is illustrated an example in which a garbage collection operation is controlled via a user interface 3110. Referring to FIG. 16, a garbage collection operation (corresponding to a period of time ta to tb) may be executed at an idle time t0 to t1 of a host 3100. That is, the memory system 3000 may perform a garbage collection operation using an idle time of the host 3100 before a write operation, via the user interface 3110. As illustrated in FIG. 16, the memory system 3000 may reduce a write time by a period of time Tg, and may have the optimal write performance regardless of the number of free blocks.

The memory system 3000 according to an embodiment of the inventive concept may perform an optimization operation on the storage device 3200 via application installation, setup of a user interface UI, a loop operation, and so on.

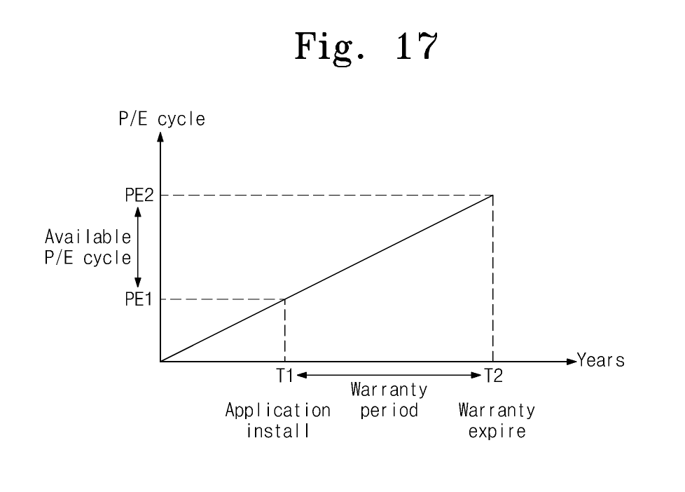

FIG. 17 is a graph for describing an application installing operation. In FIG. 17, a horizontal axis may indicate a use period of a storage device 3200 by the year, and a vertical axis may indicate a P/E cycle.

The storage device 3200 may have a P/E cycle warranty number decided according to a maker. That is, referring to FIG. 17, a P/E cycle warranty number of the storage device 3200 may be PE2. A P/E cycle at a point of time P1 when an application 3110 is installed may be PE1. An available P/E cycle may be calculated using a difference between the warranty P/E cycle PE2 and a P/E cycle PE1 at a point of time P1 when an application 3110 is installed. A memory system 3000 according to the inventive concept may calculate the remaining warranty period (T2−T1) of the storage device 3200 via the available P/E cycle (PE2−PE1).

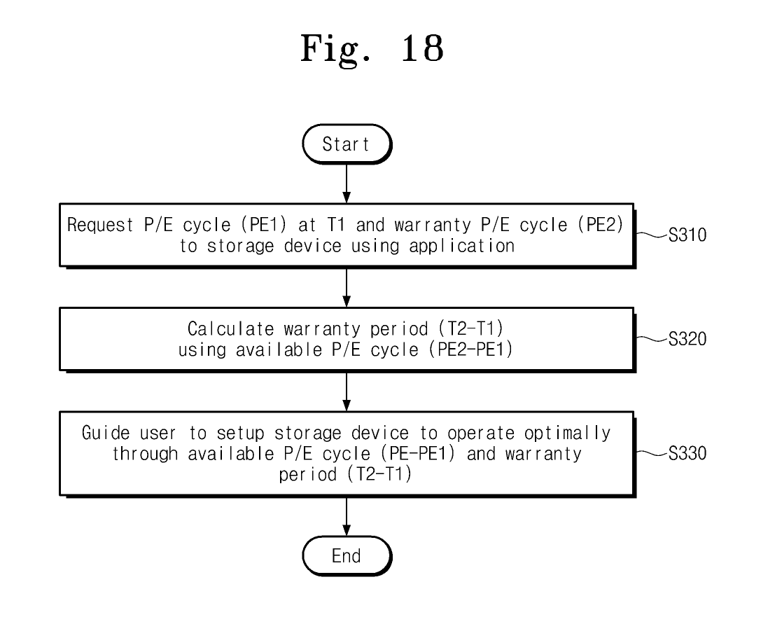

FIG. 18 is a flow chart schematically illustrating an application installing operation. Referring to FIG. 18, in operation S310, a P/E cycle PE1 at an application installation point of time T1 and a warranty P/E cycle PE2 may be requested at a storage device 3200 using an application 3110. In operation S320, lifetime T2 of product or a warranty period (T2−T1) may be calculated using an available P/E cycle (PE2−PE1). In operation S330, a user may be guided to set up the storage device 3200 such that the storage device 3200 operates at an optimal condition.

The memory system 3000 according to an embodiment of the inventive concept may recommend optimization setup on the storage device 3200 using an available P/E cycle (PE2−PE1) and a warranty period (T2−T1) of the storage device 3200. A user may decide a recommend level on a performance enhancement level of the storage device 3200 in a direction the user wants, based on the optimization setup.

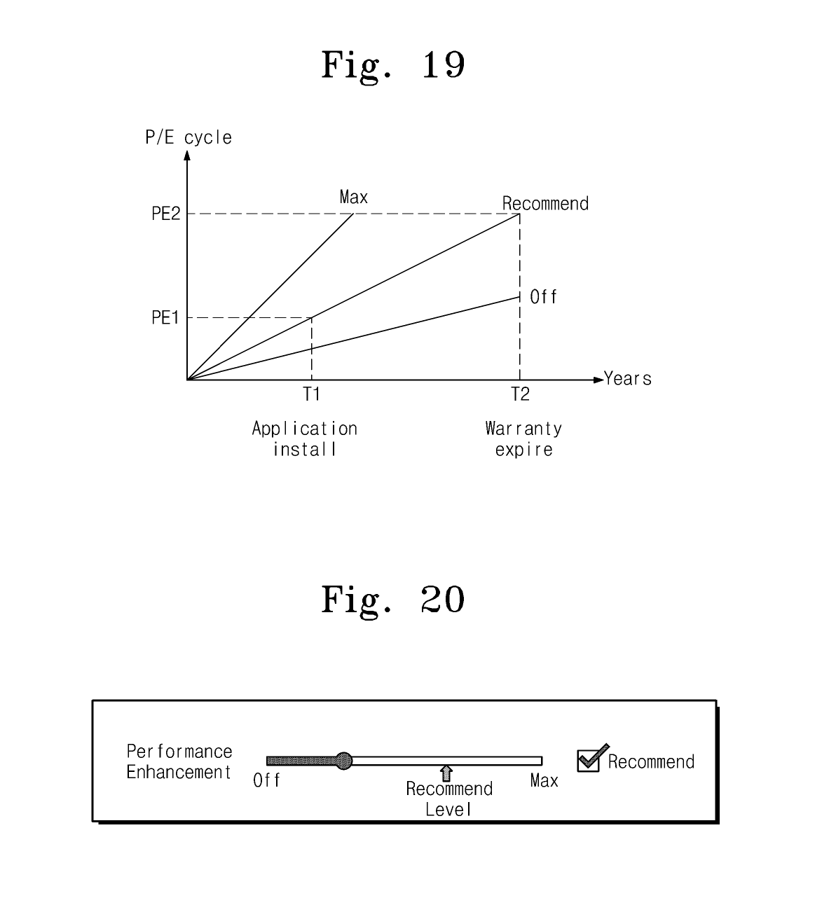

FIG. 19 is a graph for describing a method of deciding a performance enhancement level of a storage device via UI setup of a user. FIG. 20 is a diagram schematically illustrating UI setup of a user.

Referring to FIGS. 19 and 20, performance enhancement of a storage device 3200 may be controlled between an OFF level and a MAX level. A memory system 3000 may provide a user with a recommend level. The OFF level may correspond to the case that a performance enhancement function is lowest, and the MAX level may correspond to the case that a performance enhancement function is highest. In the case that the performance enhancement function is set to be close to the MAX level by the user, the performance may be improved while a warranty period may be shortened.

As described above, the recommend level may be calculated using an available P/E cycle of the storage device 3200. The recommend level may be a level decided such that the remaining warranty period is sufficiently utilized. The recommend level may be dynamically changed via periodic checking of a state of a storage device at a loop operation, which will be described later, and information on a use time input by a user.

In FIG. 20, UI setup of the user may be accomplished through specific time execution setup, garbage collection execution time or period setup, allowable lifetime year setup, and so on.

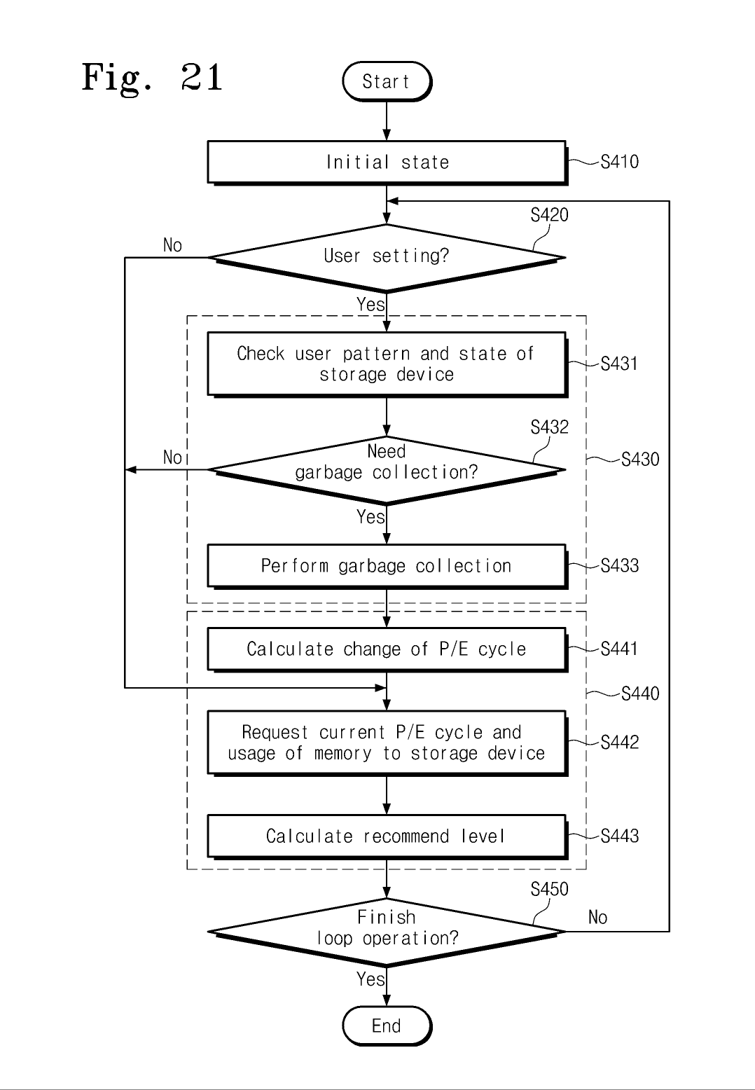

FIG. 21 is a flow chart schematically illustrating a loop operation of a memory system of FIG. 10. A memory system 3000 may check a user pattern and a storage device state via a periodic loop operation from a point of time when an application 3110 is installed. The memory system 3000 may dynamically set adjusting on an execution condition or level of garbage collection based on collected data, and may provide a user with a recommend level obtained by the checking operation via the application 3110.

In operation S410, the memory system 3000 may be at an initial state where the application 3110 is installed. In operation S420, whether a user sets an operating condition of a storage device 3200 via the application 3110 may be determined.

If user's setting does not exist, the memory system 3000 may operate at the initial state where the application 3110 is installed. That is, in operation S442, the memory system 3000 may request a current P/E cycle at the storage device 3200 and write data usage of a memory at an operating system 3120. In operation S443, the memory system 3000 may calculate a recommend level based on the requested information to provide the user with the recommend level.

Returning to operation S420, if user's setting exists, that is, if the user inputs adjusting on application execution and performance enhancement level, there may be performed a loop operation for executing background garbage collection.

Operation S430 may be performed to check a garbage collection condition and perform garbage collection. In operation S431, a user pattern and a storage device state may be checked. In operation S432, whether garbage collection is required may be determined. If garbage collection is not required, there may be performed an operation which is the same as the case that user's setting does not exist. If garbage collection is required, the method proceeds to operation S433, in which the garbage collection is performed.

A garbage collection execution condition may be decided in view of a P/E cycle, the amount of data written, a storage device self-request, trade-off relationship between performance and lifetime, and so on. That is, as described above, the memory system 3000 may analyze a user pattern or periodically check a storage device state for performance enhancement and lifetime guarantee of the storage device 3200, and may dynamically set the garbage collection execution condition using the collected information.

For example, a P/E cycle may be checked through comparison with a P/E cycle, allowed today or this week, using warranty lifetime and current P/E cycle information. The amount of data written may be decided according to whether the amount of data written in the past days or weeks exceeds a threshold value. The storage device state may be checked by reading state information through which a storage device automatically informs a host whether garbage collection is currently required. The storage device 3200 may check whether garbage collection is required, via embedded algorithm.

In operation S440, a recommend level may be calculated based on a P/E cycle change amount after execution of the garbage collection. Continuing to refer to FIG. 21, in operation S441, the P/E cycle change amount may be calculated to distinguish garbage collection executed by an application and garbage collection automatically performed by firmware. In operation S442, the memory system 3000 may request a current P/E cycle at the storage device 3200 and the amount of data written at an operating system 3120. In operation S443, the memory system 3000 may calculate a recommend level based on the requested information to provide the recommend level to the user.

In operation S450, whether to finish the loop operation may be determined. In the case that the loop operation is not finished, the method proceeds to operation S420.

As described above, the memory system 3000 according to an embodiment of the inventive concept may perform an optimization operation on the storage device 3200 via application installation, setup of a user interface UI, a loop operation, and so on. That is, the memory system 3000 may analyze a storage device state and a user pattern using a user interface to provide a user with optimization information on the storage device 3200. With the inventive concept, a setup suitable for the user or required by the user may be applied to the storage device 3200, so that the performance and reliability of the storage device 3200 are improved.

IV. Optimization Operation Method of Mobile Device Using eMMC

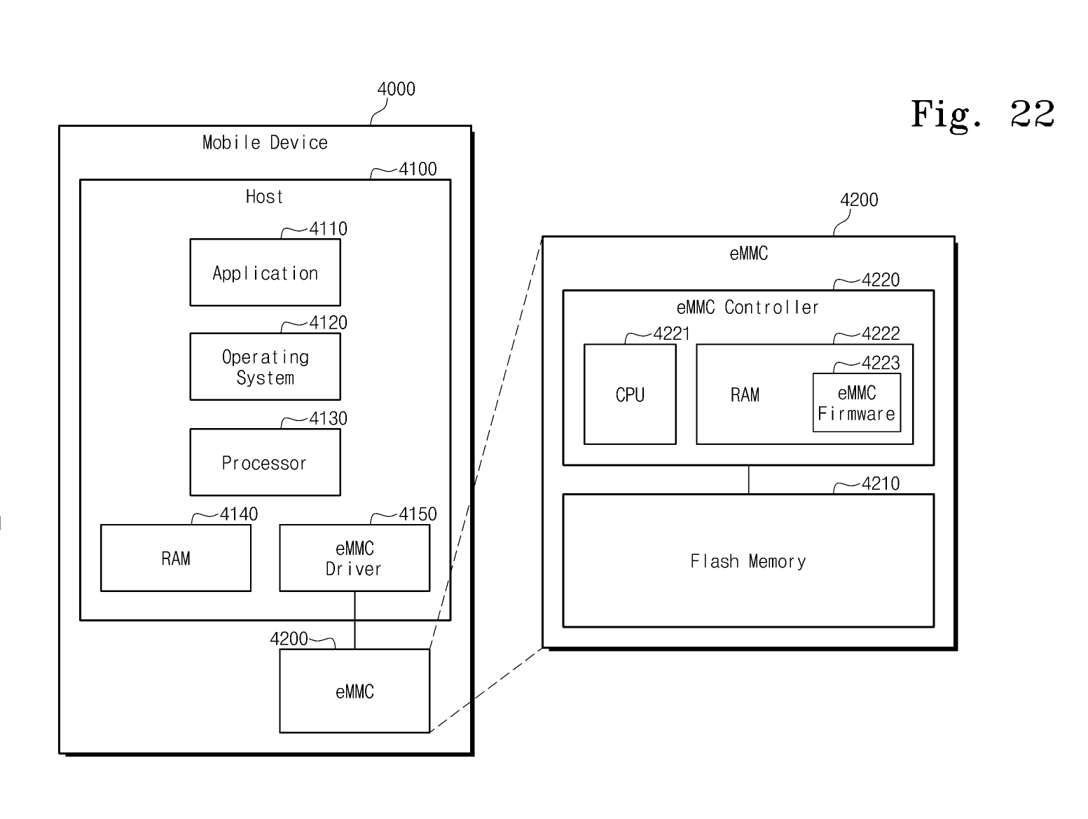

FIG. 22 is a block diagram schematically illustrating a mobile device including a memory system according to an embodiment of the inventive concept. Referring to FIG. 22, a mobile device 4000 may include a host 4100 and an embedded storage device (eMMC) 4200. The eMMC 4200 may be a memory card defined by the JEDEC standards, and may be formed of an embedded portable MMC.

The host 4100 may include an application 4110, an operating system 4120, a processor 4130, a random access memory 4140, and an eMMC driver 4150. The eMMC 4200 may include a flash memory 4210 and an eMMC controller 4220. The eMMC controller 4220 may include a CPU 4221 and a random access memory 4222. The CPU 4221 may drive eMMC firmware 4223 using the random access memory 4222.

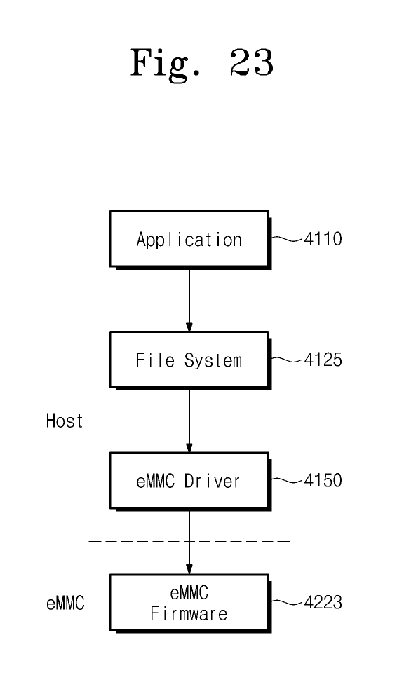

FIG. 23 is a diagram schematically illustrating a software layer structure of a mobile device of FIG. 22. Referring to FIG. 23, a mobile device 4000 according to an embodiment of the inventive concept may include a software layer structure which is formed of an application 4110, a file system 4125, an eMMC driver 4150, and eMMC firmware 4223. Herein, the application 4110, the file system 4125, and the eMMC driver 4150 may be driven at a host 4100, and the eMMC firmware 4223 may be driven at an eMMC 4200.

The host 4100 may perform functions such as OS optimization, firmware update, initialization of a storage device, adjusting of an over-provisioning area, and so on via the application 4110. The host 4100 may analyze an eMMC state and a user pattern to perform an optimization operation on the eMMC 4200.

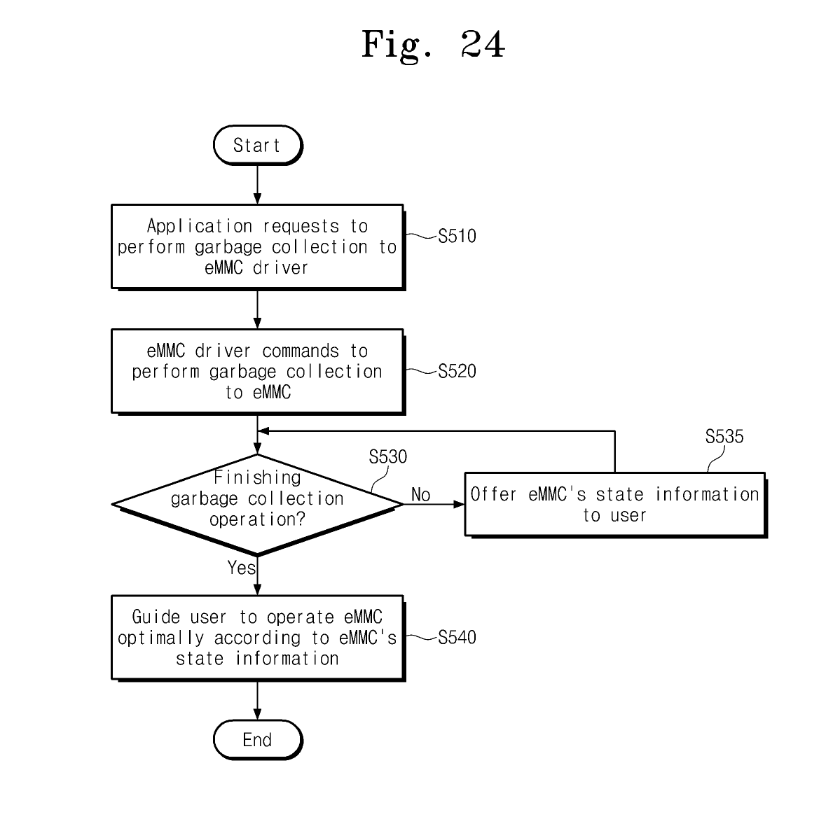

FIG. 24 is a flow chart schematically illustrating a method in which a mobile device performs a garbage collection operation via an application.

If a condition for garbage collection is satisfied, in operation S510, an eMMC driver 4150 may be requested by an application 4110 to perform garbage collection. For example, in case of an eMMC, URGENT_BKOPS or BKOPS_STATUS information may be read, and execution of the garbage collection may be requested.

The following table 1 may show a background operation status BKOPS_STATUS. In the table 1, there may be defined an interface in which the eMMC determines status information indicating whether a background operation is required and sends a determination result to an application.

TABLE 1

| | | | | | | | |
|---|---|---|---|---|---|---|---|
| Bit7 | Bit6 | Bit5 | Bit4 | Bit3 | Bit2 | Bit1 | Bit0 |

| | |
|---|---|
| Reserved | OUTSTANDING |

** description **
Bit[7:2]: Reserved
Bit[1:0]: OUTSTANDING
0x0: No operations required
0x1: Operations outstanding (non-critical)
0x2: Operations outstanding (performance being impacted)
0x3: Operations outstanding (critical)

For the application 4110 to control an execution frequency of a background operation, there may be required an interface and a function for adjusting a BKOPS_STATUS determining level of the eMMC 4200. For this, an interface for BKOPS_STATUS may be newly added.

In operation S520, an eMMC driver 4150 may issue a command to the eMMC 4200 to perform garbage collection. In operation S530, the application 4110 may determine whether a garbage collection operation of the eMMC 4200 is ended, via the eMMC driver 4150. In the case that the garbage collection operation of the eMMC 4200 is not ended, in operation S535, status information of the eMMC 4200 may be sent to a user. Afterwards, the method proceeds to operation S530. In the case that the garbage collection operation of the eMMC 4200 is ended, in operation S540, the user may be guided such that the eMMC 4200 operates at an optimal condition according to the status information of the eMMC 4200.

A mobile device 4000 according to an embodiment of the inventive concept may collect a user pattern and eMMC status information via the application 4110, and may issue an optimization operation execution command to the eMMC 4200 via the application 4110. With the inventive concept, it is possible to control the eMMC 4200 using information obtained by analyzing the user pattern. Also, the performance and reliability of the eMMC 4200 may be improved by applying a setup suitable for a user or required by the user to the eMMC 4200.

V. Applications of Memory System and Mobile Device

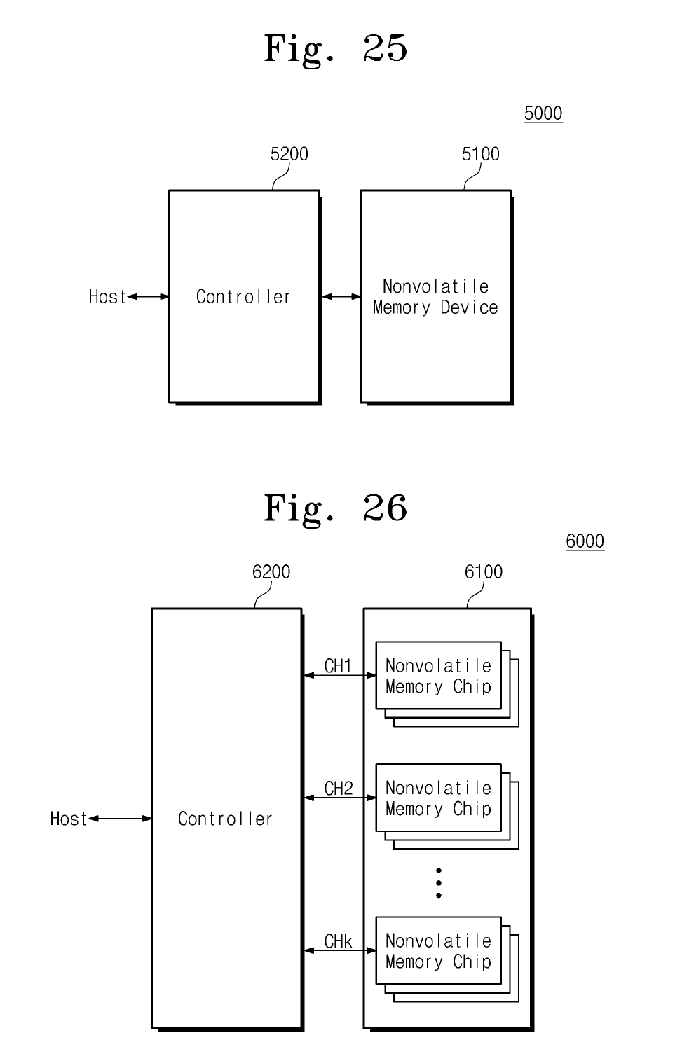

Hereinafter, a memory system according to an embodiment of the present general inventive concept and application examples thereof will be described with reference to FIGS. 25 to 27.

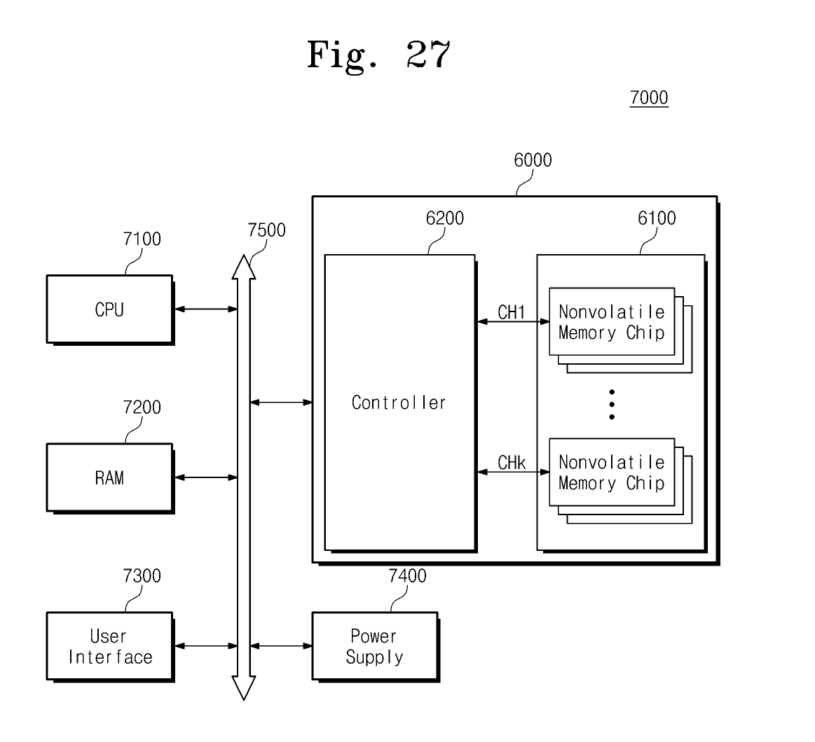

FIG. 25 is a block diagram illustrating a memory system 5000 according to an embodiment of the present general inventive concept. FIG. 26 is a block diagram illustrating a memory system 6000 as an application example of the memory system 5000 of FIG. 25. FIG. 27 is a block diagram illustrating a computing system 7000 including the memory system 6000 of FIG. 26.

Referring to FIG. 25, the memory system 5000 includes a non-volatile memory device 5100 and a controller 5200. Here, the controller 5200 and the non-volatile memory device 5100 may be integrated into a single body, for example, one semiconductor device, to constitute the above-mentioned solid state drive (SSD). The solid state drive (SSD) includes a storage device configured to store data in a semiconductor memory. In a case where the solid state drive (SSD) is used as the memory system 5000, an operation speed of a host connected to the memory system 5000 may be improved dramatically.

The controller 5200 is connected to a host and the non-volatile memory device 5100. In response to a request transmitted from the host, the controller 5200 is configured to access the non-volatile memory device 5100. For example, the controller 5200 is configured to control read, write, erase and background operations of the non-volatile memory device 5100. The controller 5200 is configured to provide an interface between the non-volatile memory device 5100 and the host. The controller 5200 is configured to operate a firmware to control the non-volatile memory device 5100.

The controller 5200 may further include well-known components such as a random access memory (RAM), a processing unit, a host interface, and a memory interface. The RAM is used as at least one of an operation memory of the processing unit, a cache memory between the non-volatile memory device 5100 and the host, and a buffer memory between the non-volatile memory device 5100 and the host. The processing unit controls all operations of the controller 5200.

The host interface includes a protocol to perform data exchange between the host and the controller 5200. For example, the controller 5200 is configured to perform communication with an external device (for example, host) through at least one of various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, and an integrated drive electronics (IDE) protocol. The memory interface interfaces with the non-volatile memory device 1100. For example, the memory interface includes a NAND interface or NOR interface.

The memory system 5000 may be configured to additionally include an error correction block. The error correction block is configured to detect and correct an error of data read from the non-volatile memory device 5100 using an error correction code (ECC). As an example, the error correction block is provided as a component of the controller 5200. The error correction block may be provided as a component of the non-volatile memory device 5100.

As another example, the memory system 5000 is provided as one of various components of an electronic apparatus, such as a computer, ultra mobile PC (UMPC), workstation, net-book, personal digital assistants (PDA), portable computer, web tablet, wireless phone, mobile phone, smart phone, e-book, portable multimedia player (PMP), portable game console, navigation device, black box, digital camera, 3-dimensional television, digital audio recorder, digital audio player, digital picture recorder, digital picture player, digital video recorder, digital video player, apparatus capable of transmitting and receiving information in wireless environment, one of various electronic apparatuses constituting the home network, one of various electronic apparatuses constituting the computer network, one of various electronic apparatuses constituting the telematics network, radio-frequency identification (RFID) device, and one of various components forming the computing system.

Specifically, the non-volatile memory device 5100 or the memory system 5000 may be mounted as various types of packages. For example, the non-volatile memory device 5100 or the memory system 5000 may be mounted as a package such as package on package (PoP), ball grid arrays (BGAs), chip scale packages (CSPs), plastic leaded chip carrier(PLCC), plastic dual in line package (PDIP), die in waffle pack, die in wafer form, chip on board (COB), ceramic dual in line package (CERDIP), plastic metric quad flat pack (MQFP), small outline (SOIC), shrink small outline package (SSOP), thin small outline (TSOP), thin quad flat pack (TQFP), system in package (SIP), multi-chip package (MCP), wafer-level fabricated package (VVFP), wafer-level processed stack package (WSP).

Referring to FIG. 26, the memory system 6000 includes a non-volatile memory device 6100 and a controller 6200. The non-volatile memory device 6100 includes a plurality of non-volatile memory chips. The non-volatile memory chips are classified into a plurality of groups. Each group of the non-volatile memory chips is configured to perform communication with the controller 6200 via one common channel. For example, the non-volatile memory chips perform communication with the controller 6200 via a number of channels, for example, first to k-th channels CH1 to CHk.

Although FIG. 26 illustrates a plurality of non-volatile memory chips connected to one channel, it can be understood that the memory system 6000 may be modified such that one non-volatile memory chip is connected to one channel.

Referring to FIG. 27, the computing system 7000 includes a central processing unit 7100, a random access memory (RAM) 7200, a user interface 7300, a power supply 7400, and the memory system 6000.

The memory system 6000 is electrically connected to the central processing unit 7100, the RAM 7200, the user interface 7300 and the power supply 7400 via a system bus 7500. The data provided through the user interface 7300 or processed by the central processing unit 7100 is stored in the memory system 6000.

FIG. 27 illustrates a case where the non-volatile memory device 6100 is connected to the system bus 7500 through the controller 6200. However, the non-volatile memory device 6100 may be configured to be directly connected to the system bus 7500.

Although FIG. 27 illustrates the memory system 6000 described as the memory system 6000 of FIG. 26, the memory system 5100 of FIG. 25 can be used as the memory system 6000 of FIG. 27.

For instance, the computing system 7000 may be configured to include both of the memory systems 5000 and 6000 described with reference to FIGS. 25 and 26.

The inventive concept may not be limited to a flash memory device. The inventive concept may be applied to all storage devices which perform address conversion via a translation layer.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A memory system comprising:
a storage device including a flash memory; and
a host configured to request a storage device state and user pattern information via a user interface, to analyze the user pattern information, to set up a parameter of the storage device such that the storage device operates an optimization operation, according to the analyzing result, and to provide a command for the optimization operation to the storage device.

2. The memory system of claim 1, wherein the storage device state is at least one of a P/E cycle and a background operation state.

3. The memory system of claim 2, wherein the user pattern information is at least one of the amount of data written, a memory access type, and a memory access time.

4. The memory system of claim 2, wherein the host calculates an expected value of lifetime of the storage device using the P/E cycle and provides the calculated result to a user.

5. The memory system of claim 4, wherein the host provides the user with a recommend level for the optimization operation of the storage device.

6. The memory system of claim 1, wherein the user interface is an application.

7. The memory system of claim 6, wherein the host informs a user of a progress state of the storage device via the application and guides an operation setup on the storage device.

8. The memory system of claim 1, wherein the storage device is an embedded memory device.

9. The memory system of claim 8, wherein the embedded memory device is an embedded multi-media card (eMMC).

10. The memory system of claim 1, wherein the host performs self-diagnosis and self-healing operations on the storage device.

11. The memory system of claim 10, wherein the self-healing operation is accomplished by switching hot data and cold data, performing a data reclaim operation, controlling an over-provisioning area, changing a parameter, or by changing a program condition.

12. The memory system of claim 1, wherein the storage device and the host constitute a mobile device.

13. The memory system of claim 12, wherein the storage device is an embedded multi-media card (eMMC).

14. An operating method of a mobile device which includes a storage device and a host, comprising:
requesting a storage device state and user pattern information via a user interface;
analyzing the user pattern information;
setting up a parameter of the storage device such that the storage device operates an optimization operation, according to the analyzing result; and
providing a command for the optimization operation to the storage device.

15. The operating method of claim 14, further comprising:
providing a recommend level for the optimization operation to a user.

16. The operating method of claim 14, wherein the storage device state is at least one of a P/E cycle and a background operation state, and the user pattern information is at least one of the amount of data written, a memory access type, and a memory access time.

17. The operating method of claim 14, further comprising:
informing a user of a progress state of the storage device via the application; and
guiding an operation setup on the storage device.

18. The operating method of claim 14, further comprising:
calculating an expected value of lifetime of the storage device using the P/E cycle to provide the calculated result to a user.

19. The operating method of claim 14, further comprising:
performing self-diagnosis and self-healing operations on the storage device.

20. The operating method of claim 19, wherein the self-healing operation is accomplished by switching hot data and cold data, performing a data reclaim operation, controlling an over-provisioning area, changing a parameter, or by changing a program condition.
